(19) United States
(12) Patent Application Publication
(10) Pub. No.: US 2014/0337761 A1
(43) Pub. Date: Nov. 13, 2014

(54) LOCATING AND SHARING AUDIO/VISUAL CONTENT

(71) Applicant: Bart H. Glass, Atlanta, GA (US)

(72) Inventor: Bart H. Glass, Atlanta, GA (US)

(73) Assignee: BHG VENTURES, LLC, Atlanta, GA (US)

(21) Appl. No.: 13/925,198

(22) Filed: Jun. 24, 2013

Related U.S. Application Data
(60) Provisional application No. 61/664,296, filed on Jun. 26, 2012.

(51) Int. Cl. H04L 29/06

(52) U.S. Cl. CPC H04L 65/403
USPC 715/753

(57) ABSTRACT

A system and method are provided for locating and sharing audio/visual content. The method includes receiving a text-based search request for audio/visual content and searching a storage based on the text-based search request. A list of audio/visual content that is determined to be relevant to the text-based search request is presented. A selection of an original audio/visual content file from the list of audio/visual content is received. Next, a corresponding text file for the original audio/visual content file is retrieved. The text in the text file is time-synced to the original audio/visual file. All or a portion of the corresponding lyrics file is presented and a text selection from the corresponding text file is received. A secondary file is created that comprises a portion of the original audio/visual content file that corresponds to the selected text.

### RELATED APPLICATIONS

This application claims the benefit of priority to provisional application No. 61/664,296, filed Jun. 26, 2012, entitled “Systems and Methods for Mapping and Editing Digital Content,” the entire contents of which are hereby incorporated herein by reference. This application also is related to non-provisional application Attorney Docket No. 074622-458627, filed on the same date as this application, entitled “Locating and Sharing Audio/Visual Content,” the entire contents of which are hereby incorporated herein by reference.

### FIELD

The present systems and methods relate generally to computer hardware and software systems for editing and disseminating digital content, and more particularly to systems, apparatuses, and methods associated with creating, editing, and communicating snippets of audio/visual content associated with time-synced textual content, wherein the textual content is, for example, in the form of a narration, dialog, conversation, musical lyrics, etc.

### BACKGROUND

The widespread popularity and continually evolving growth of the Internet has resulted in a significant interest in the distribution of digital content. Thus, for example, the music and entertainment industries are developing systems that allow users to acquire and utilize digital content from online digital content stores, digital content owners, content publishers, third party content distributors, or any other legalized content repositories.

From a user perspective, the Internet has created an increasingly connected human society wherein users stay electronically well-connected with each other. Consequently, in today's fast-paced life, this has created the need for short, efficient and yet effective communications. People, more so than before, communicate their emotions, sentiments, memories, thoughts, feelings, etc. in short information bursts involving instant messages, SMS or MMS messages, social media posts, and the like. In many scenarios, people express their emotions by sharing snippets of digital content with their family members, friends, or acquaintances. Examples of such digital content include audio/visual content such as music, video, movies, TV shows, etc. It will be generally understood that a snippet of digital content is a segment of digital content between two instants of time. Snippets can involve digital content relating to a narration, dialog, conversation, lyrics associated with a video, audio, or generally any audio or audio and video (audio/visual) file.

Traditionally, users who wish to create and communicate snippets to other users can do so by using a complex and specific software that extracts such snippets from an audio/visual file. However, such traditional systems are cumbersome and have several disadvantages. For example, in many scenarios, users do not have access to the audio/visual file because of ownership or copyright issues. Even if users are able to obtain a copy of the audio/visual file, in several instances, users have to review the entire audio/visual file in order to search for the snippet because users do not know the specific instants of time corresponding to a beginning and an end of a desired snippet, relative to the audio/visual file. If the audio/visual file is of a long duration, searching for a desired segment can cost a lot of a user's valuable time, causing anger and frustration. In various instances, users may have to repeatedly review the audio/visual file to precisely figure out the timing of the beginning and an end of a snippet in order to then extract the desired snippet. This solution is very cumbersome and relies on the user's ability to precisely align the start and stop points via listening to the audio, which can be very cumbersome and lacks the necessary precision to produce exact results for numerous reasons, including the fact that the audio is not always clear and easily understandable. Additionally, the resulting audio/visual files may not be readily stored on social media networks, emailed, or shared with other people.

Therefore, there is a long-felt but unresolved need for a system and method that enables users to create snippets of digital content without the need to review the entire audio/visual file or relying on the user to hear the exact timing of the desired snippet, and is not cumbersome unlike traditional systems. A well-designed sophisticated system also enables users to search for audio/visual content using text-based searches. The system should enable users to edit audio/visual content directly from a related text file that stores textual information corresponding to the audio/visual content. Additionally, a system that creates snippets of audio/visual content merged with time-synced textual content would be highly interactive and provide greater levels of user engagement and appreciation. In other words, in addition to delivering the segment of actual audio/visual content, an option of a system should also deliver textual information extracted from a narration, dialog, conversation, or musical lyrics within that segment. Also, in order to create widespread social engagement, a system should enable users to share snippets via different social channels for expressing human emotions. Examples of such social channels include social media networks, digital greeting cards, digital gift cards, digital photographs, and various others. Also, the system should be easily operated by users having minimal technical skills

### SUMMARY

Briefly described, and according to one embodiment, aspects of the present disclosure generally relate to systems and methods for discovering, creating, editing, and communicating snippets of audio/visual content based on time-synced textual content, wherein the textual content is, for example, in the form of a narration, dialog, conversation, musical lyrics, etc. and appearing inside the audio/visual content. According to one embodiment, the time-synced textual content is delivered to users in conjunction with the audio/visual content as a single file, in multiple files, or even as a “file container” comprising multiple files. According to another embodiment, the time-synced textual content is delivered to the user via streaming. According to another embodiment, the time-synced textual content is not delivered to users, or alternately, delivered to users based on a user's desire to receive such content. According to yet another embodiment, the time-synced textual content is selected by users using hand movements on the touch screen display of an electronic device, or by cursor movements that can be reviewed on the screen of a computer.

Aspects of the present disclosure generally relate to locating and sharing audio content and/or audio and video content (audio/visual content herein) using a content mapping and editing system (CMES) and methods for creating, editing, and communicating snippets of audio/visual content without the need to review the entire audio/visual file or use complicated editing software. Audio/visual (A/V) content can include TV shows, movies, music, speech, instructional videos, documentaries, pre-recorded sports events etc., or virtually any kind of audio or video file and in any digital format. As generally referred to herein, a snippet of digital content is a segment of digital content between two instants of time, wherein a snippet has a distinct beginning and end.

In one embodiment, a user highlights or otherwise selects portions in a text file corresponding to an audio/visual file (e.g., music lyrics corresponding to an audio file for an associated song) corresponding to the snippet(s) that he or she requests. In one aspect, the disclosed system creates snippets of audio/visual content comprising time-synced textual content in conjunction with the audio/visual content, wherein the textual content is extracted from narrations, dialogs, conversations, musical lyrics, etc. within the audio/visual content. The audio/visual content can reside either within databases operatively connected to the CMES, or such content can also be stored locally on (or, connected externally to) the user's computing device, for example, inside a media library.

In one exemplary aspect, the snippets (alternately referred to herein as secondary audio/visual content) are created in a suitable digital format and subsequently delivered to users via a delivery mechanism involving email, SMS or MMS message, streaming to users' computing devices, downloadable web link, mobile application software programs (mobile apps), or the like.

In one aspect, the disclosed system comprises a digital repository of time-synced (time-mapped) information that is a mapping between textual information identified at specific time-stamps within the audio/visual content. In other words, the mapping identifies textual information (such as lines within a song or words inside a speech) occurring within the audio/visual content and the corresponding time-stamps of occurrence, relative to the audio/visual content. As will be generally understood, such a repository (comprising mappings between textual information and time stamps) can be created on-the-fly when a user's request for creating a snippet is being processed by the CMES. Alternately, such a repository can also be pre-created and stored in a digital database. In an exemplary aspect, the disclosed system enables users to share snippets of audio/visual content (overlaid with time-synced textual content), via one or more social channels for expressing human emotions. Examples of such social channels include SMS/MMS messages, social media network posts, electronic greeting cards, electronic gift cards, digital photos, and various others. As will be understood, such sharing functionalities enable snippets to be shared with other persons, such as a user's friends, family, colleagues, or any other persons.

In another aspect, a system, a method, and a non-transitory computer-readable medium share a portion of a primary audio/visual content file. The method includes receiving, by at least one processor, a selection of a primary audio/visual content file. The method further includes retrieving, by the at least one processor, a text file that has text corresponding to audio in the primary audio/visual content file. Next, text from the text file is presented for display and a text selection from the text file is received. A secondary file is created which comprises a portion of the primary audio/visual content file, where the portion has a start time and stop time from the primary audio/visual content file that correspond to the text selection. Thus, the portion of the primary audio/visual content file can be shared with a recipient.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system environment in which an embodiment of the disclosed content mapping and editing system (“CMES”) is utilized to locate and share audio/visual content.

FIGS. 2A-2C illustrate flowcharts showing high-level, computer-implemented method steps illustrating an exemplary CMES process, performed by various software modules of the CMES, according to one embodiment of the present system.

FIG. 3 is a flowchart showing an exemplary time-mapped database creation process, according to one embodiment of the present system.

FIGS. 4A-4F illustrate use cases of the example embodiments.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

### Overview

Aspects of the present disclosure generally relate to locating and sharing audio/visual content using a content mapping and editing system (CMES) and methods for creating, editing, and communicating snippets of audio/visual content without the need to review the entire audio/visual file or use complicated editing software. Audio/visual (A/V) content can include TV shows, movies, music, speech, instructional videos, documentaries, pre-recorded sports events etc., or virtually any kind of audio or video file and in any format. As generally referred to herein, a snippet of digital content is a segment of content between two instants of time, wherein a snippet has a distinct beginning and end. In one embodiment, a user highlights portions of text from a text file corresponding to an audio/visual file (e.g., music lyrics corresponding to an audio file for an associated song) corresponding to the snippet(s) that he or she requests. In one aspect, the disclosed system creates snippets of audio/visual content comprising time-synced textual content in conjunction with the audio/visual content, wherein the textual content is extracted from narrations, dialogs, conversations, musical lyrics, etc. within the audio/visual content. In one exemplary aspect, the snippets are created in a suitable digital format and subsequently delivered to users via a delivery mechanism involving email, SMS or MMS message, streaming to users' computing devices, downloadable web link, mobile application software programs (mobile apps), or the like.

In one aspect, the disclosed system comprises a digital repository of time-synced (time-mapped) information that is a mapping between textual information identified at specific time-stamps within the audio/visual content. In other words, the mapping identifies textual information (such as lines within a song or words inside a speech) occurring within the audio/visual content and the corresponding time-stamps of occurrence, relative to the audio/visual content. The time-mapped information may be included with the text of the audio in a single file, such as a time-stamped text file, or in separate files. As will be generally understood, such a repository (comprising mappings between textual information and time stamps) can be created on-the-fly when a user's request for creating a snippet is being processed by the CMES. Alternately, such a repository can also be pre-created and stored in a digital database. In an exemplary aspect, the disclosed system enables users to share snippets of audio/visual content (in conjunction with time-synced textual content), via one or more social channels for expressing human emotions. Examples of such social channels include SMS/MMS messages, social media network posts, electronic greeting cards, electronic gift cards, and various others. As will be understood, such sharing functionalities enable snippets to be shared with other persons, such as a user's friends, family, colleagues, or any other persons.

### Exemplary Embodiments

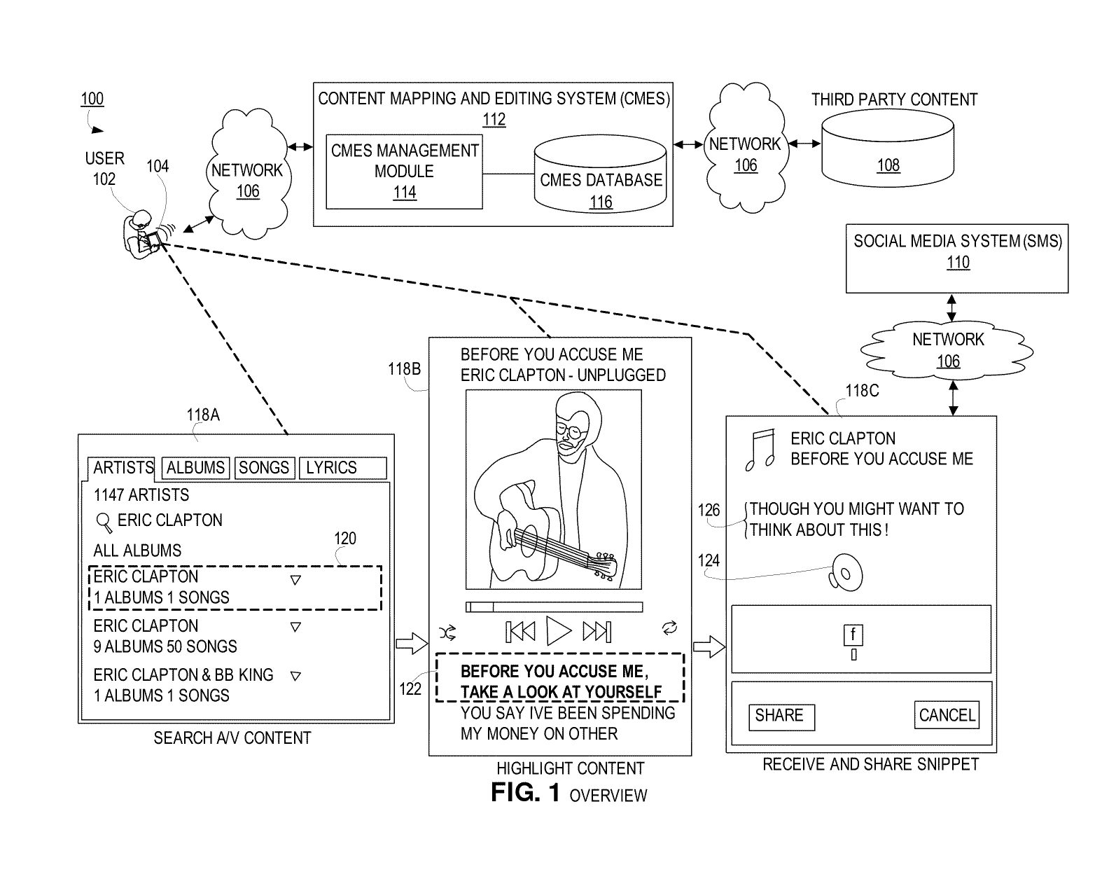

Referring now to the figures, FIG. 1 illustrates an exemplary embodiment 100 of a content mapping and editing system (CMES) 112 for locating and sharing audio/visual content in an exemplary environment, constructed and operated in accordance with various aspects of the present disclosure. As shown, the CMES 112 includes a CMES manager 114 (also generally synonymous with CMES management module or CMES management computer system) executed by one or more processors for carrying out various computer-implemented processes of the CMES. In one aspect, the computer-implemented processes include applying speech or voice recognition technologies to an audio/visual file for creating textual information extracted from a narration, dialog, conversation, or musical lyrics from the audio/visual content. In another aspect, the computer-implemented processes include using time stamping software to manually chart out the times at which textual information occur inside the audio-visual content. In yet another aspect, the CMES 112 enables users to create a secondary audio/visual file from a primary audio/file, wherein the secondary audio/visual file comprises a snippet of the primary audio/visual file. In one embodiment, a user selects (via a digital device interface) a portion of a text file corresponding to the textual content corresponding to the snippet. Subsequently, the audio/visual content corresponding to the snippet is packaged in the secondary audio/visual file and communicated to users. In one exemplary aspect, the secondary audio/visual file additionally comprises the textual content corresponding to the snippet.

In one embodiment, the CMES 112 uses or creates a text file, such as a metadata file, that contains both the text of the file corresponding to the audio in the audio file or audio/video file and also contains the time stamps to indicated the time the text occurs in the audio file or audio/video file (referred to as a time-stamped text file herein). That is, the text file includes the text corresponding to the audio or audio/video file (for example, lyrics in a lyric text file or audio from a movie) and timing tags (alternately referred to as time stamps) that specify the time the text occurs in the corresponding audio or audio/video file (for example, the song file or the movie file). The time stamps may include, for example start times and stop times for a group of words, a time stamp for each word or a group of words, or time stamps for one or more strings of characters. In one example, a text file contains both the text for lyrics and time stamps to synchronize the lyrics with a music audio or audio/video file. In another embodiment, the timing data may be in a separate file from the text.

In one embodiment, the CMES 112 uses or creates the text file, such as a metadata file, in an LRC file format. An LRC file is a computer file format for a lyrics file that synchronizes song lyrics with an audio file, such as MP3, Vorbis, or MIDI. Though, the LRC file format at least is modified to include stop times and changes in start times and/or stop times (“timing data”) for one or more words, groups of words, phrases, or character strings. LRC files can be in both a simple and enhanced format. The enhanced format supports a time tag or time stamp per line. In one example, an LRC file format is used or modified to include the text of a text file (for example, lyrics in a lyric text file or audio from a movie) and timing tags (alternately referred to as time stamps) that specify the time the text occurs in the corresponding audio file (for example, the song file or the movie file). The text file may have the same name as the audio file, with a different filename extension. For example, an audio file for Song may be called song.mp3, and the text file for Song may be called song.lrc. The LRC format is text-based and similar to subtitle files. A different file format or unique file format with timing data for text corresponding to audio or audio/video may be used.

In one example of a time-stamped metadata file or time-stamped text file used in an example embodiment, one or more words or groups of words or phrases in the text file have time stamps that identify the start time at which the phrase or group of words occur in the corresponding audio file or audio/video file. For example:

Before you accuse me, take a look at yourself

[00:20]Before you accuse me, take a look at yourself

[00:29]You say I've been spending my money on other women

[00:32]You've been taking money from someone else

[00:39]1 called your mama 'bout three or four nights ago

[00:49]1 called your mama 'bout three or four nights ago

[00:58]Well your mother said “Son”

[01:01]“Don't call my daughter no more”

[01:08]Before you accuse me, take a look at yourself

[01:18]Before you accuse me, take a look at yourself

[01:27]You say I've been spending my money on other women

[01:31]You've been taking money from someone else

[02:06]Come back home baby, try my love one more time

[02:16]Come back home baby, try my love one more time

[02:25] 1f 1 don't go on and quit you

[02:29] 1'm gonna lose my mind

[02:35]Before you accuse me, take a look at yourself

[02:45]Before you accuse me, take a look at yourself

[02:54]You say I've been spending my money on other women

[02:58]You've been taking money from someone else

In another example of a time-stamped metadata file or a time-stamped text file used in an example embodiment, one or more words in the text file have a time stamp that identifies the start time at which the one or more words occur in the corresponding audio file or audio/video. For example:

[00:29]You say I've been

[00:30]spending my money

[00:31]on other women

In another example of a time-stamped metadata file or a time-stamped text file used in an example embodiment, each word in the text file has a time stamp that identifies the start time at which the word occurs in the corresponding audio file or audio/video. For example:

[00:20]Before

[00:21]you

[00:22]accuse

[00:23]me,

[00:24]take

[00:25]a

[00:26]look

[00:27]at

[00:28]yourself

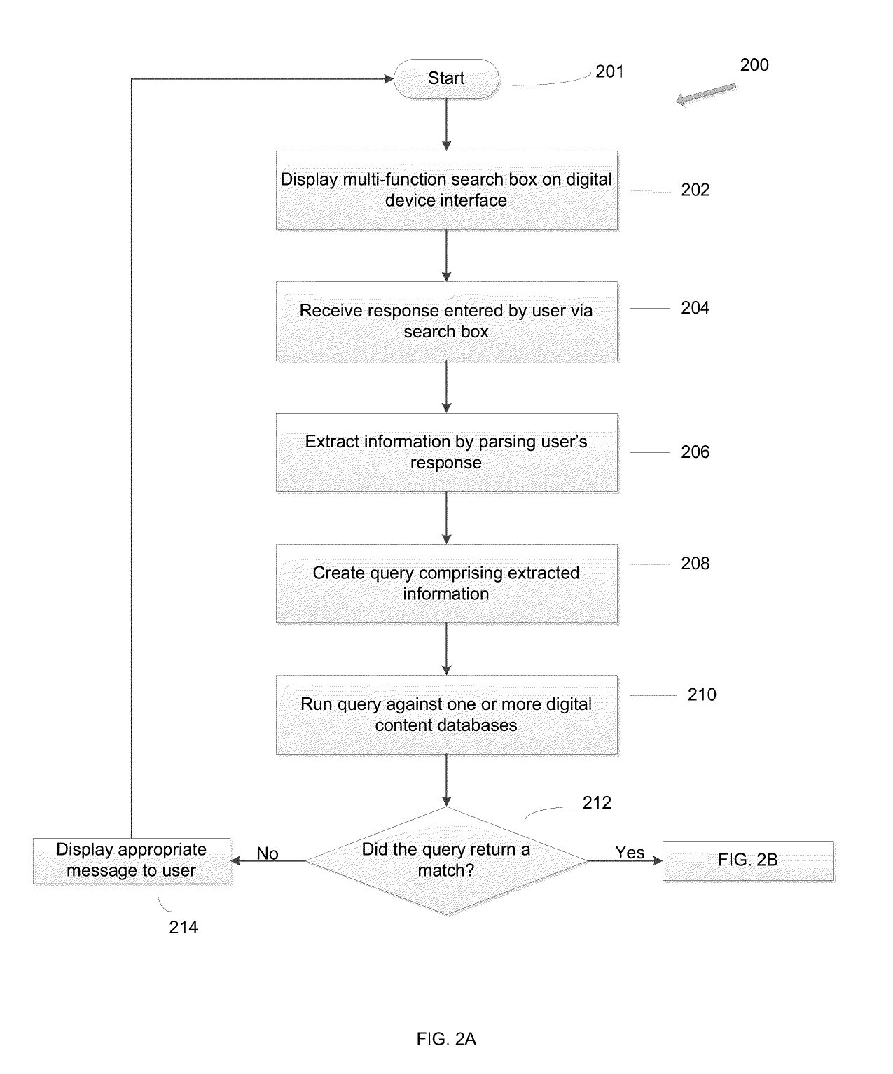

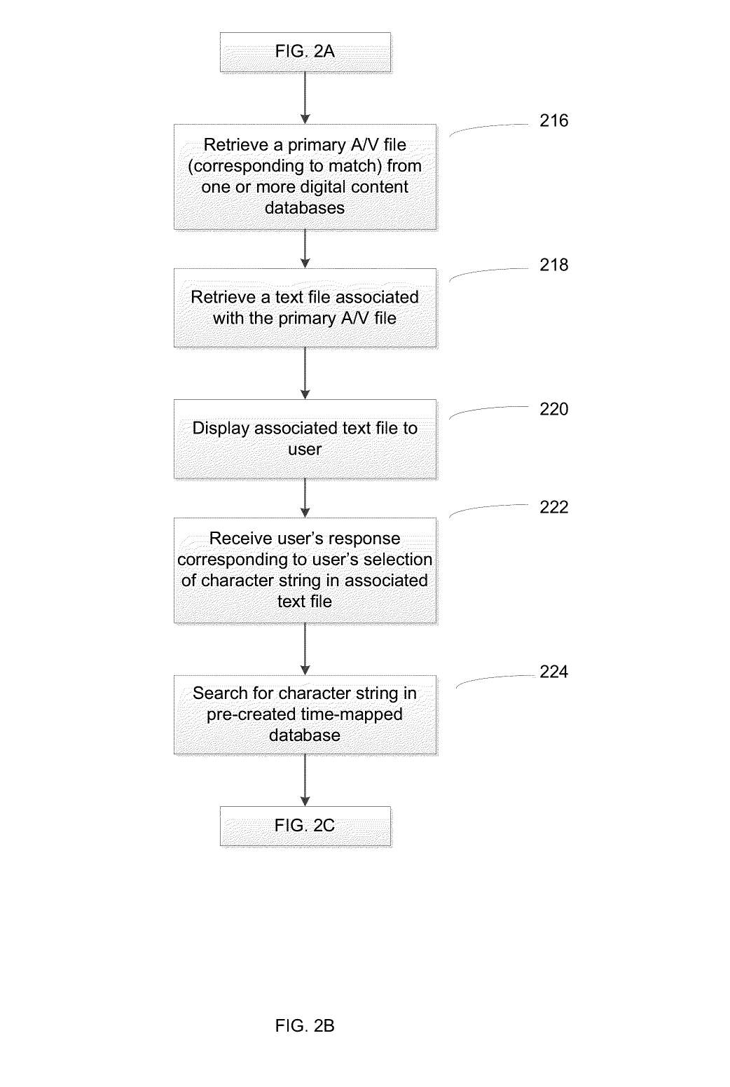

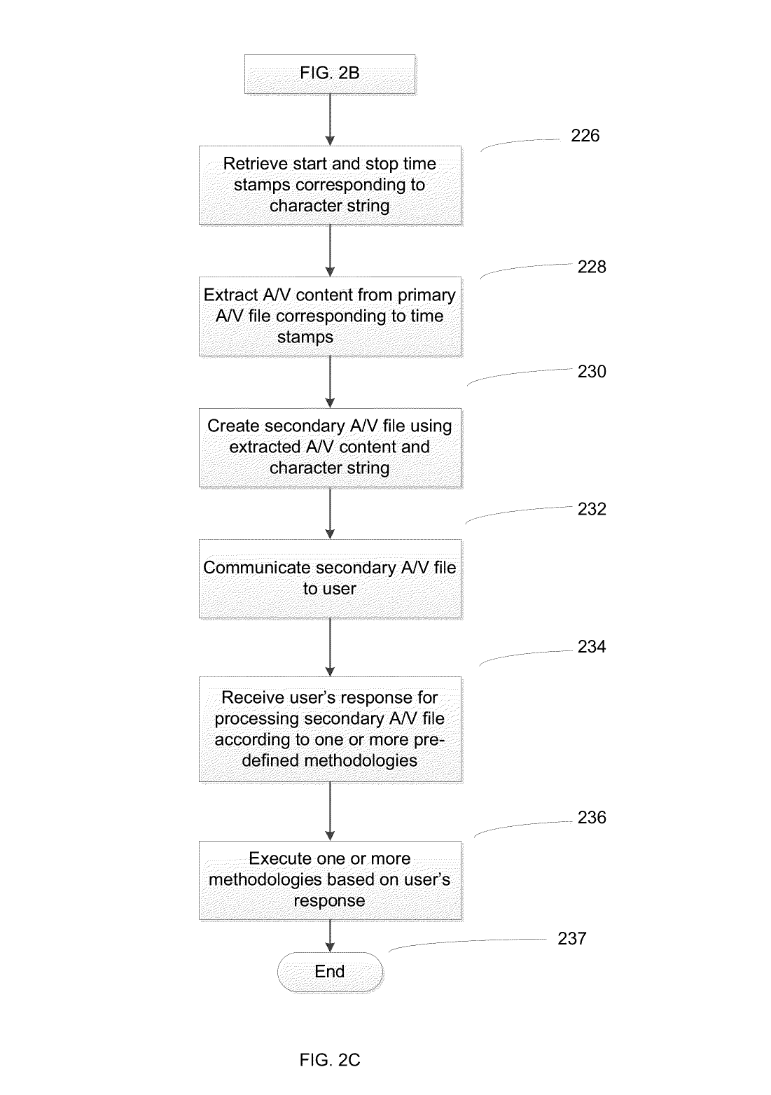

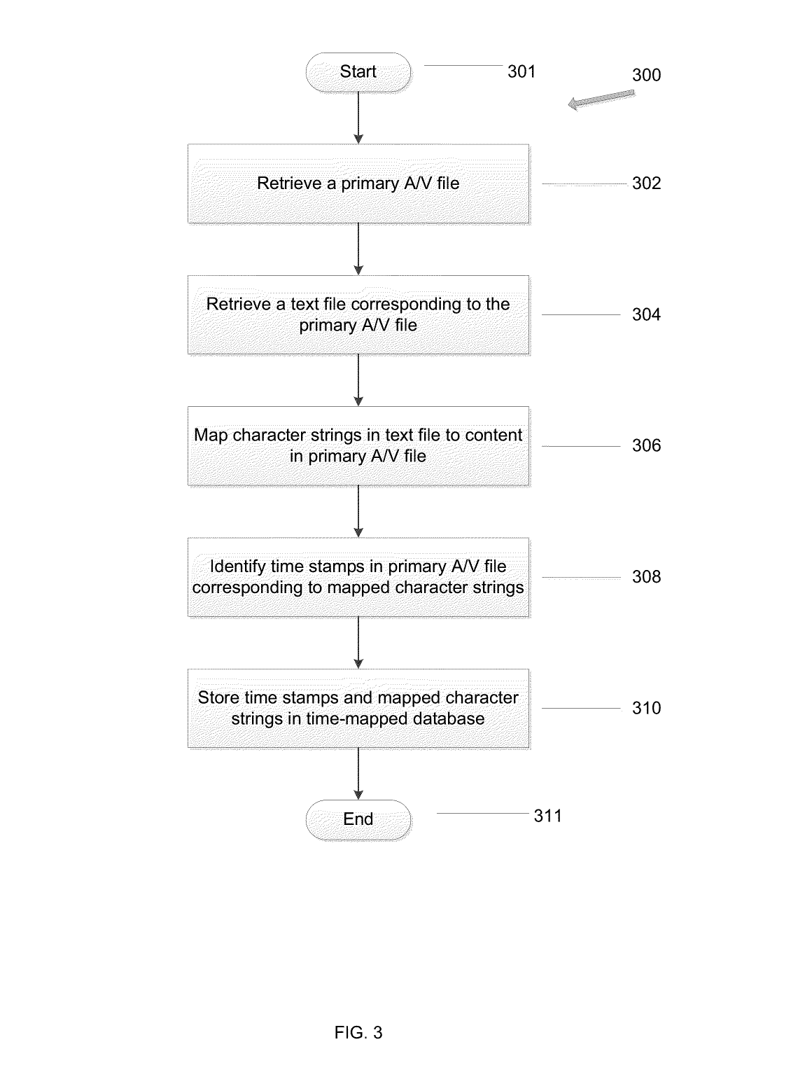

In yet another aspect, the CMES 112 provides functionalities to integrate snippets of audio/visual content with SMS/MMS messages, electronic cards, gift cards, etc., or even share the snippets via social media networks, according to a user's preferences. In another exemplary aspect, the CMES 112 enables users to share digital photographs in conjunction with snippets of audio/visual content, e.g., the photographic information is not lost, however the snippet is “tagged” or integrated with a photograph. Details of exemplary CMES processes will be discussed in connection with FIGS. 2A-2C and FIG. 3. Further, the CMES 112 also includes one or more CMES databases 116 for storing audio/visual content, text files relating to textual information extracted from the audio/visual content, user data, and various other data attributes. Moreover, in yet another aspect, the CMES management module 114 executes different program modules or rules, as necessary to be implemented by owners/operators of the digital library in connection with billing end users, as well as managing a relationship with third party content providers 108.

In one embodiment, the CMES 112 includes operative (including wireless) connections to users 102, third party content providers 108, social media systems 110, via one or more data communication networks 106, such as the Internet. It will be generally understood that third party content providers 108 are distributors and/or publishers of audio/visual content (such as e-books, movies, music, audio files, TV shows, documentaries, pre-recorded sports events, or any other type of electronic media content). Generally, the CMES 112 stores audio/visual content as available from third party content providers 108, e.g., in the form of a master catalog. In one embodiment, the master catalog is frequently updated by the CMES 112 to reflect changes in availability, pricing, licensing agreements, or any inventory changes as communicated by the third party content providers 108.

According to one aspect, the operative connections involve a secure connection or communications protocol, such as the Secure Sockets Layer (SSL) protocol. Furthermore, it will be understood by one skilled in the art that communications over networks 106 typically involves the usage of one or more services, e.g., a Web-deployed service with client/service architecture, a corporate Local Area Network (LAN) or Wide Area Network (WAN), or through a cloud-based system. Moreover, as will be understood and appreciated, various networking components like routers, switches, hubs etc., are typically involved in the communications. Although not shown in FIG. 1, it can also be further understood that such communications may include one or more secure networks, gateways/firewalls that provide information security from unwarranted intrusions and cyber attacks. Communications between the CMES 112 and the third party content providers 108 typically proceed via Application Programming Interfaces (APIs) or via email, or even via formatted XML documents.

As referred to herein, users 102 are typically persons who utilize the CMES 112 to create snippets of audio/visual content. As will be understood, various types of computing devices can be used by users 102 to access the CMES 112, and there is no limitation imposed on the number of devices, device types, brands, vendors and manufacturers that may be used. According to an aspect of the present disclosure, users 102 access the CMES 112 using a CMES user interface (e.g., a website or a web portal) hosted by the CMES 112, via networks connections 106 using devices 104 such as computers (e.g., laptops, desktops, tablet computers, etc.) or mobile computing devices (e.g., smart phones) or even dedicated electronic devices (e.g., mp3 players for music, digital media players etc.) capable of accessing the world wide web. In other aspects, the CMES user interface is integrated with another third party system, mobile application, or platform. Generally speaking, and as will be understood by a person skilled in the art, the CMES user interface is a webpage (e.g., front-end of an online digital library portal) owned by the CMES 112, accessible through a software program such as a web browser. The browser used to load the CMES interface can be running on devices 104. Examples of commonly used web browsers include but are not limited to well-known software programs such as MICROSOFT™ INTERNET™ EXPLORER™, MOZILLA™ FIREFOX™, APPLE™ SAFARI™, GOOGLE™ CHROME™, and others. According to an aspect, an embodiment of the CMES (including the CMES user interface) is hosted on a physical server, or alternately in a virtual “cloud” server, and further involves third party domain hosting providers, and/or Internet Service Providers (ISPs).

In alternate aspects, the CMES user interface can also be configured as a mobile application software program (mobile app) such as that available for the popular APPLE™ IPHONE™ AND GOOGLE™ ANDROID™ mobile device operating systems. According to other alternate aspects, the CMES website configured as a mobile device application can co-exist jointly with the CMES website (or, web portal) accessible through a web browser.

For purposes of example and explanation, it can be assumed that users 102 initially register with an embodiment of the CMES 112. The registration (usually a one-time activity) can be accomplished in a conventional manner via a CMES user interface, or via a mobile device application program that communicates with the CMES 112. During registration, the user 102 may provide relevant information, such as the user's name, address, email address, credit/debit card number for billing purposes, affiliations with specific social media networks (such as FACEBOOK™, TWITTER™, MYSPACE™ etc.), preferences for specific social channels (such as electronic greeting cards, digital photos, electronic gift cards) and other similar types of information. Typically, as will be understood, information provided by system users during registration is stored in an exemplary CMES database 116.

Next, after registration is successful, a user logs into the CMES 112 and requests the CMES 112 to create snippets. Exemplary user interfaces 118A, 118B, and 118C shown in FIG. 1 display various successive stages illustrating creation of snippets, viewed through a web browser or a mobile app. In the disclosed embodiment, creation of snippets begins with the user first searching for audio/visual content, e.g., by typing in one or more text-based character strings as search criteria. For instance, a user can search for audio/visual content by typing in a few keywords, such as lyrics of a song, dialogs or conversations in a movie, or any other character strings. Specifically, in one embodiment, the CMES 112 provides multi-function search capabilities to users, including suggestions of a complete word based on a character string, partially entered by the user 102, and various other functions as will occur to one skilled in the art. Users can also search by genres, song name, movie name, artist name, or any other relevant classification of the audio/visual content, as will occur to one of ordinary skill in the art. In the next few paragraphs, an example will be illustrated wherein a user 102 creates a snippet 124 comprising a couple of lines from an exemplary song, attaches the same along with a SMS or MMS text, and communicates the same with another person. A high-level summary of interactions (between the CMES 112 and the user 102) involved in this hypothetical example is illustrated with CMES interfaces 118A, 118B, and 118C, e.g., appearing on the user's mobile device 104.

As shown in exemplary interface 118A in FIG. 1, a user 102 types in “eric clapton” as a character string, and the CMES in turn displays a list of search results related to “eric clapton”, e.g., by assembling information related to “eric clapton” as available in the CMES database 116. Then the user selects one (e.g., as shown in region 120) of the displayed search results. Consequently, the CMES retrieves the audio/visual content corresponding to the user's selection from the CMES database, and then in one example, plays the audio/visual content using a media player. Further, the CMES 112 also retrieves a text file corresponding to the audio/visual content. In the example shown in FIG. 1, the displayed text file comprises the lyrics of a song called “Before you accuse me” that belongs to an album called “eric clapton unplugged”.

Accordingly, in one embodiment, a user highlights portions in a text file to indicate textual information extracted from the audio/visual content. According to another embodiment, the user highlights the desired portions (i.e., used in creating a snippet) with hand movements on the touch screen display of an electronic device, or by cursor movements that can be reviewed on the screen of a computer, or by any other text highlighting/selection mechanism. The highlighted portion in FIG. 1 that will be used in creating a snippet is the textual information “Before you accuse me, take a look at yourself.” An exemplary CMES interface 118B displaying the highlighted portion (shown in region 122) of a text file is shown in FIG. 1. As will be understood, the CMES receives the user's selection (e.g., highlighted textual content 122) via the user interface. According to aspects of the present disclosure, the CMES 112 extracts the portion (corresponding to the textual content highlighted in region 122) of the song “Before you accuse me” from an audio file, creates a snippet using the extracted portion, and delivers the snippet to the user 102.

Continuing with the description of FIG. 1, the CMES searches for the character string highlighted by the user in a pre-created time-mapped database. A time-mapped database (generally, a part of CMES database 112) is a digital repository of mappings between textual information identified at specific time-stamps within the audio/visual content. In other words, the mapping identifies textual information (such as lines, words, or even individual characters relating to lyrics of a song, dialog of a TV show, etc.) occurring within the audio/visual content and the corresponding time-stamps of occurrence, relative to the audio/visual content. As will be generally understood, such a repository (comprising mappings between textual information and time stamps) can be created on-the-fly when a user's request for creating a snippet is being processed by the CMES 112. Alternately, such a repository can also be pre-created and stored in a digital database. Thus, aspects of the time-mapped database may possibly relate to usage of speech recognition technologies, as known to one skilled in the art. An exemplary CMES process for creation of a time-mapped database will be discussed in connection with FIG. 3.

In one aspect, the disclosed system creates snippets of time-synced content that is displayed along with the corresponding textual content. As shown with the example in FIG. 1, the textual content (e.g., the lyrics shown in region 122) is highlighted by a user 102 in conjunction with the actual audio/visual content. In other words, the snippet of audio/visual content comprises a segment (clip) of the song corresponding to the textual content highlighted by the user 102, in addition to the associated textual content.

Finally, the CMES communicates the snippet to the user for subsequent use. Such a snippet is received by the user as a file downloadable from a web link or, in the form an email attachment, or other suitable delivery mechanisms. As shown in user interface 118C, the snippet is shown as a file 124. After the user receives the snippet, the user can share the snippet, e.g., as an MMS message 126. Additionally, users can also choose to share the snippet with friends and family, via posts or messages on social media systems 110. Although not shown in FIG. 1, it will be understood that embodiments of the disclosed CMES 112 execute various pre-defined methodologies that enable users to share snippets 124 via various other social channels for expressing human emotions. Examples of such social channels include electronic greeting cards, electronic gift cards, digital photo tags, and various others.

The discussions above in association with FIG. 1 merely provide an overview of an embodiment of the present system for discovering, creating, editing, and communicating snippets of audio/visual content. In one exemplary embodiment, the snippet is created with the audio/visual content in conjunction with time-synced textual content, wherein the textual content relates to a narration, dialog, conversation, musical lyrics, etc. inside the audio/visual content. Accordingly, it will be understood that the descriptions in this disclosure are not intended to limit in any way the scope of the present disclosure. As will be understood and appreciated, the specific modules and databases in FIG. 1 are shown for illustrative purposes only, and embodiments of the present system are not limited to the specific details shown. For example, it has been discussed previously that the CMES 112 creates snippets from audio/visual content (typically made available from third party content providers 118). However, it will be understood and appreciated that in one embodiment, the CMES 112 provides users with the functionality to create snippets from audio/visual content stored locally inside (or, externally connected to) the user's computing device, for example, inside a media library. In such an example, the user uploads the audio/visual content to a CMES website via a web-based app that could be installed within the user's computing device, or accessible via a web browser. Alternately, the CMES website is configured to interact with the user via a mobile app residing on the user's mobile computing device. The functions and operations of the CMES management module 114 and CMES generally (in one embodiment, a server or collection of various software modules, processes, sub-routines or generally, algorithms implemented by the CMES) will be better understood from details of various computer-implemented processes as described in greater detail below.

FIGS. 2A-2C illustrate an exemplary process 200 that is performed by various modules and software components associated with an embodiment of the content mapping and editing system 112 for purposes of discovering, creating, editing, and communicating snippets of audio/visual content corresponding to time-synced textual content, wherein the textual content is, for example, in the form of a narration, dialog, conversation, musical lyrics, etc.

The process begins in step 201. Starting at step 202, the CMES 112 displays a multi-function search box on an interface of a digital device, wherein the interface is associated with a CMES web portal via a web-based app that could be installed within the user's computing device, or accessible via a web browser. Alternately, the interface is associated with a mobile app running on a user's web-enabled computing device. In one embodiment, the CMES 112 provides multi-function search capabilities to users, including suggestions of a complete word based on a character string, partially entered by the user 102, and various other functions as will occur to one skilled in the art. Users can also search by genres, song name, movie name, artist name, mood or sentiment, or any other relevant classification of the audio/visual content, as will occur to one of ordinary skill in the art. Next, the user types his or her response (e.g., search criteria) into the search box, which is received by the CMES 112 at step 204. As will be generally understood, information typed by a user typically comprises alphanumeric text as search criteria. At step 206, the CMES extracts information by parsing the user's response. Then, the CMES 112 runs (at step 210) a query against one or more content databases comprising audio/visual content.

Such databases can belong to third party content providers 108, or can be housed within the CMES 112. At step 212, the CMES determines whether or not the query returned a match. If the CMES 112 is unable (at step 214) to find a match, it communicates or displays an appropriate message notifying the user at step 214. Consequently, the process 200 returns back to step 202.

However, if the CMES 112 determines that there was a match, then the process 200 moves to step 216 wherein the CMES 112 retrieves a primary audio/visual file from the one or more content databases. Next, at step 218, the CMES retrieves a text file associated with the primary audio/visual file. The CMES 112 causes this text file (or, a portion thereof) to be displayed to the user at step 220, and the CMES waits (not shown in FIG. 2B) for the user's response. At the following step 222, the CMES 112 receives the user's response corresponding to the user's selection of character strings in the text file. In one embodiment, the user's selection of character strings happens when the user highlights portions of text in a text file. For example, the user highlights (or, generally edits) a few lines or stanzas of music lyrics in a text file that contains the lyrics of a song. Then, as will be understood better from the discussions that follow, the user's highlighted portion is used by the CMES to create the snippet of audio/visual content. In an exemplary scenario, the song is assumed to be stored in an audio file (generally referred to herein as primary audio/visual content), and the snippet of audio/visual content is generally referred to herein as secondary audio/visual content.

Continuing with the description of FIG. 2B, at step 224, the CMES 112 searches for a match between the user's selection of character strings and a time-mapped database. Such a database stores specific time stamps of the occurrence of words, lines, or characters in the primary audio/visual content. In a hypothetical editing scenario, a user highlights the line “We are the world” from an exemplary song called “Winds of Change”, and assuming that this song has the line “We are the world” occurring in three instances at 5 seconds, 10 seconds, and then at 1 minute 12 seconds from the beginning of a song, then in one exemplary CMES embodiment, the time stamps are denoted in the database as the following time mapping: “We are the world”—00:00:05, 00:00:10, and 00:01:12. (Steps involved in creating a time-mapped or time-synced database is explained in connection with FIG. 3.) Next, at step 226, the CMES 112 retrieves time stamps corresponding to the user's selection of character strings.

According to an exemplary embodiment, after retrieving the time stamps, the CMES 112 extracts (at step 228) the audio/visual content (e.g. “We are the world”) from the primary file (e.g., the song “Winds of Change”) corresponding to the time stamps (e.g., 00:00:05, 00:00:10, and 00:01:12). The audio/visual content may be extracted from pre-stored synchronized digital content and/or on-the-fly extraction. Then, at step 230, the CMES 112 creates a secondary file comprising the extracted audio/visual content. In one embodiment, if the extracted audio/visual content appears multiple times within the primary audio/visual file, then the CMES 112 creates the secondary file with a single instance of the extracted audio/visual content. (In reference to the above example, the extracted audio/visual content appears three (3) times within the original song.) In alternate embodiments, the secondary file (created by the CMES 112) comprises all instances. In several CMES embodiments, the secondary file also comprises textual information (character string highlighted by the user) in the extracted audio/visual content and is also delivered to users. That is, in connection with the above example, the secondary file comprises the digital audio “We are the world” in conjunction with the corresponding text “We are the world.”

Next, the secondary file is communicated to the user at step 232. The secondary file (alternately referred to herein as snippet of audio/visual content) is created in a suitable digital format and typically delivered to users via a delivery mechanism involving email, SMS or MMS message, downloadable web link, mobile application software programs (mobile apps), or the like.

In many CMES embodiments, users are further given the option to share the secondary file with other persons via different social channels for expressing human emotions. Examples of such social channels include social media networks (such as FACEBOOK™ TWITTER™, LINKEDIN™, and the like), digital greeting cards, digital gift cards, digital photographs, and various others. Thus, at step 234, the CMES receives the user's response indicating a preference to share the secondary file via one or more social channels (i.e., such sharing typically occurs according to pre-defined methodologies associated with such channels). Next, the CMES executes (at step 236) various pre-defined methodologies to facilitate the sharing of the secondary file via one or more social channels. The CMES process 200 ends in step 237.

As will be understood and appreciated, the steps of the process 200 shown in FIGS. 2A-2C are not necessarily completed in the order shown, and various steps of the CMES may operate concurrently and continuously. Accordingly, the steps shown in FIGS. 2A-2C are generally asynchronous and independent, computer-implemented, tied to particular machines, and not necessarily performed in the order shown. Also, various alternate embodiments of the CMES can be developed, and are considered to be within the scope of this disclosure. For example, although not shown herein, a CMES embodiment can provide a preview of the extracted audio/visual content to users, before creating the secondary file, as discussed above. Such a preview will allow users to verify whether the yet-to-be-created secondary file correctly represents the portion of the audio/visual content that is highlighted by the user.

It will be understood from the previous discussions, the CMES can first create a time-mapped database that contains a synchronized mapping between textual information (such as lines, words, or even individual characters relating to lyrics of a song, dialog of a TV show, etc.) identified by the CMES as occurring within the audio/visual content and the corresponding time-stamps of the same. In one embodiment, the CMES 112 pre-creates such a database and uses it in conjunction with the process discussed in FIGS. 2A-2C. In another embodiment, the textual information and time mappings are created on-the-fly as a user request for creation of snippets is being processed by the CMES. However, it will be understood that the CMES steps involved in generating textual information and time mappings are generally the same, regardless of whether the mapping occurs in advance or at the time of editing. In what follows next, an embodiment of a time-mapped database creation process will be described in greater detail.

Now referring to FIG. 3, an embodiment of an exemplary time-mapped database creation process 300, is shown. The process begins in step 301. Starting at step 302, the CMES 112 retrieves a primary audio-visual content file. Examples of such an audio/visual content file include files relating to music, movies, TV shows, etc. Next, at step 304, the CMES 112 retrieves a text file comprising textual information, wherein the textual information is in the form of a narration, dialog, conversation, musical lyrics, etc. that corresponds (or, relates) to the primary audio/visual content. In one aspect, the text file is generated by using automatic speech recognition technologies, as will occur to one skilled in the art. In another aspect, the text file is disseminated by the third party content provider 108. (For a detailed discussion example on primary audio/visual file, secondary audio/file, time maps, and other elements of the disclosure, refer to FIGS. 2A-2C.)

At step 304, the CMES 112 retrieves a text file (e.g., a lyrics file corresponding to a song stored in audio file), wherein the text file comprises textual information relating to the primary audio/visual content. Next, the text file is parsed (not shown in FIG. 3). Then, at step 306, the CMES 112 time maps character strings (in the text file) with the audio/visual content as it appears in the primary audio/visual file so text in the text file has a corresponding time stamp. Also, at step 308, time instances (e.g., time stamps with respect to the beginning of the primary audio/visual file) of occurrence of such character strings in the primary audio/visual file are identified. Finally, at step 310, the CMES 112 stores the identified time stamps in a time-mapped database (alternatively referred to as time-synched database). The process ends in step 311.

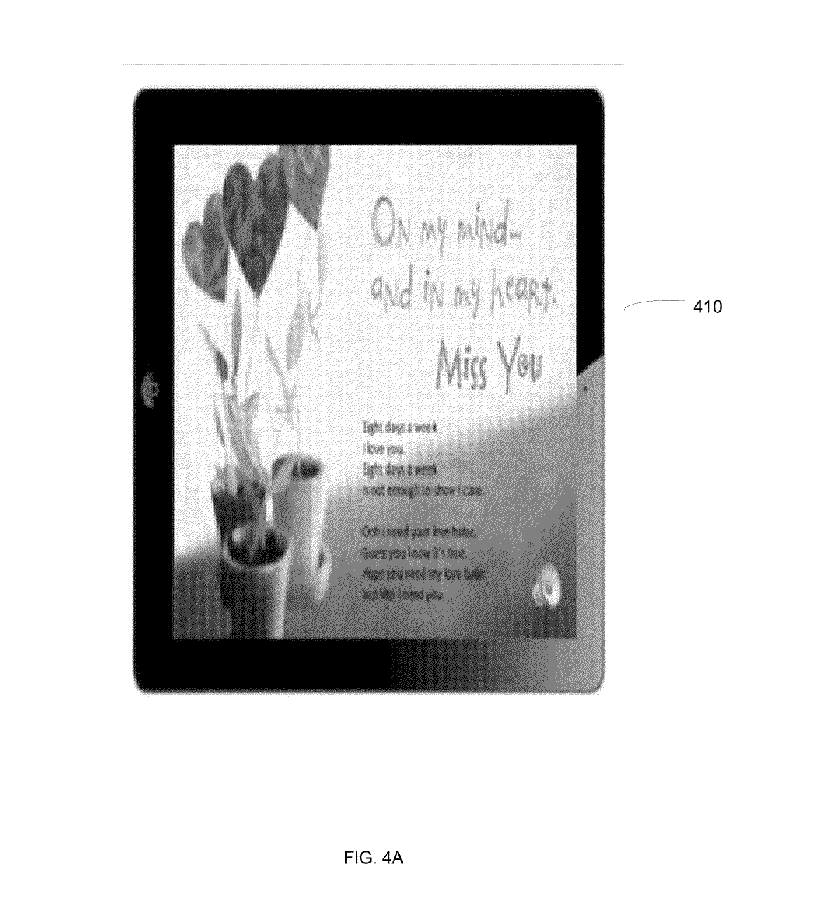

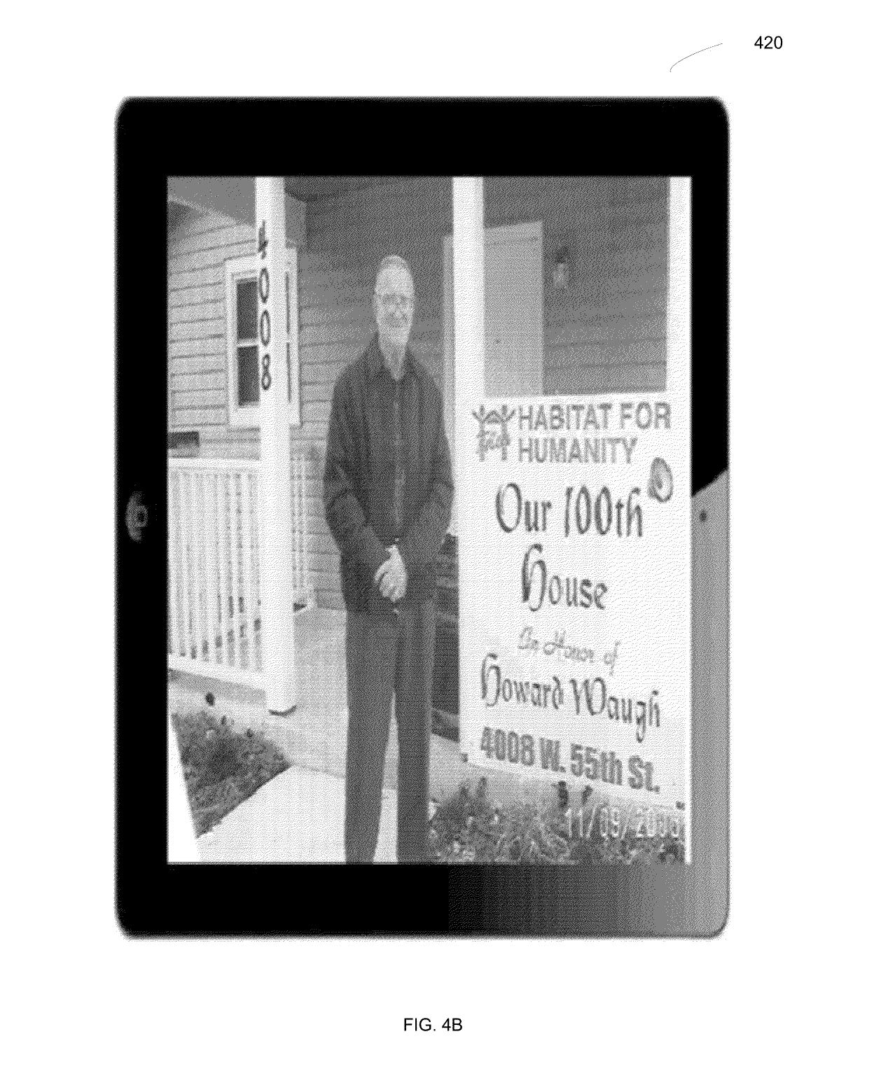

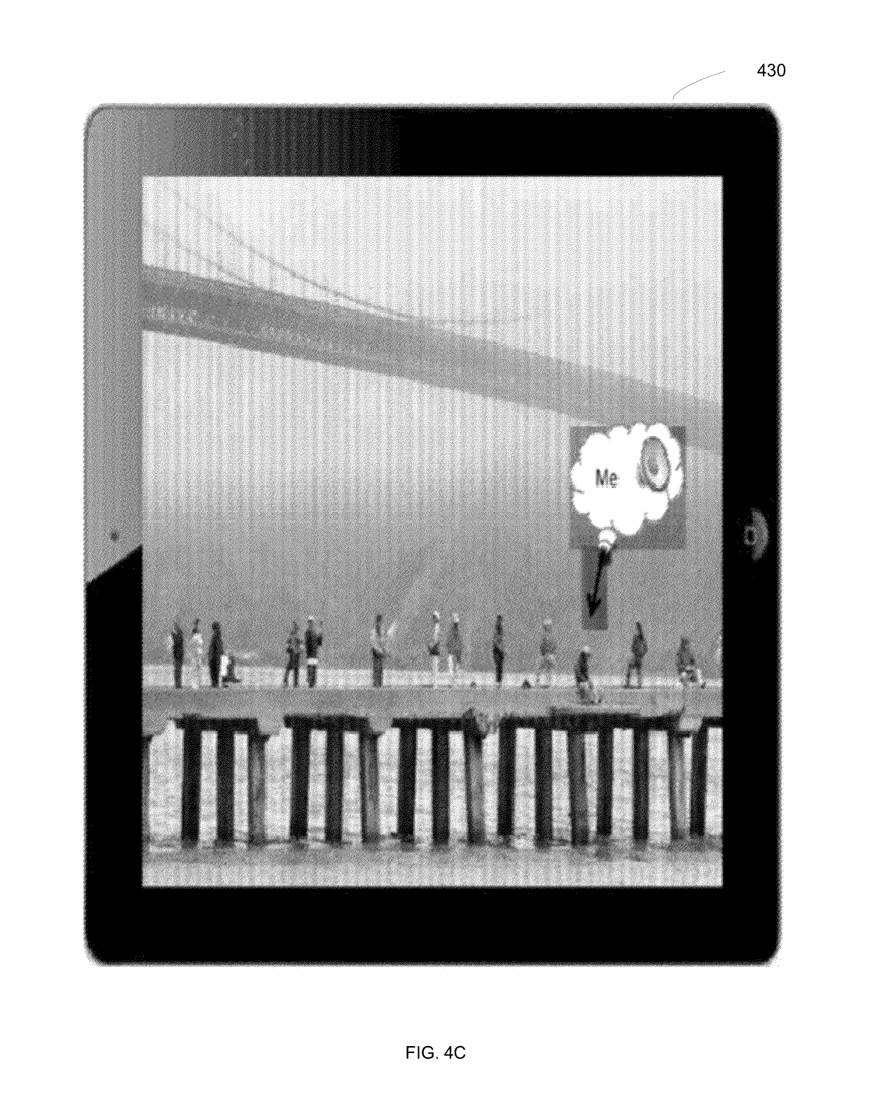

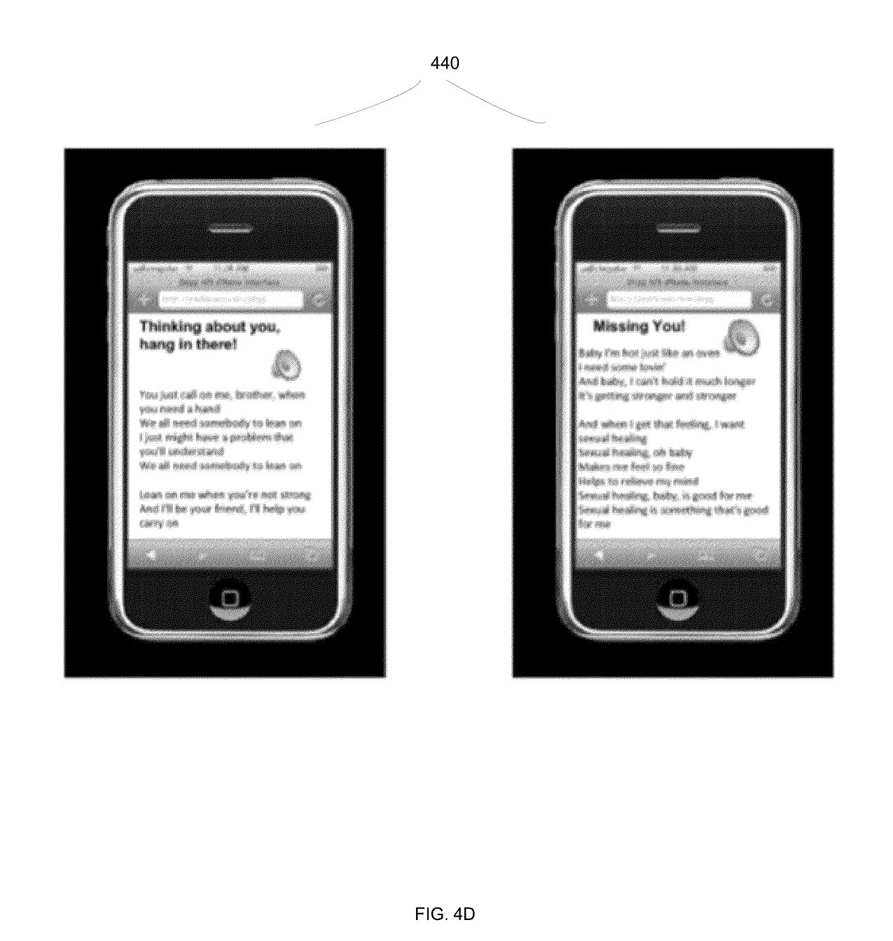

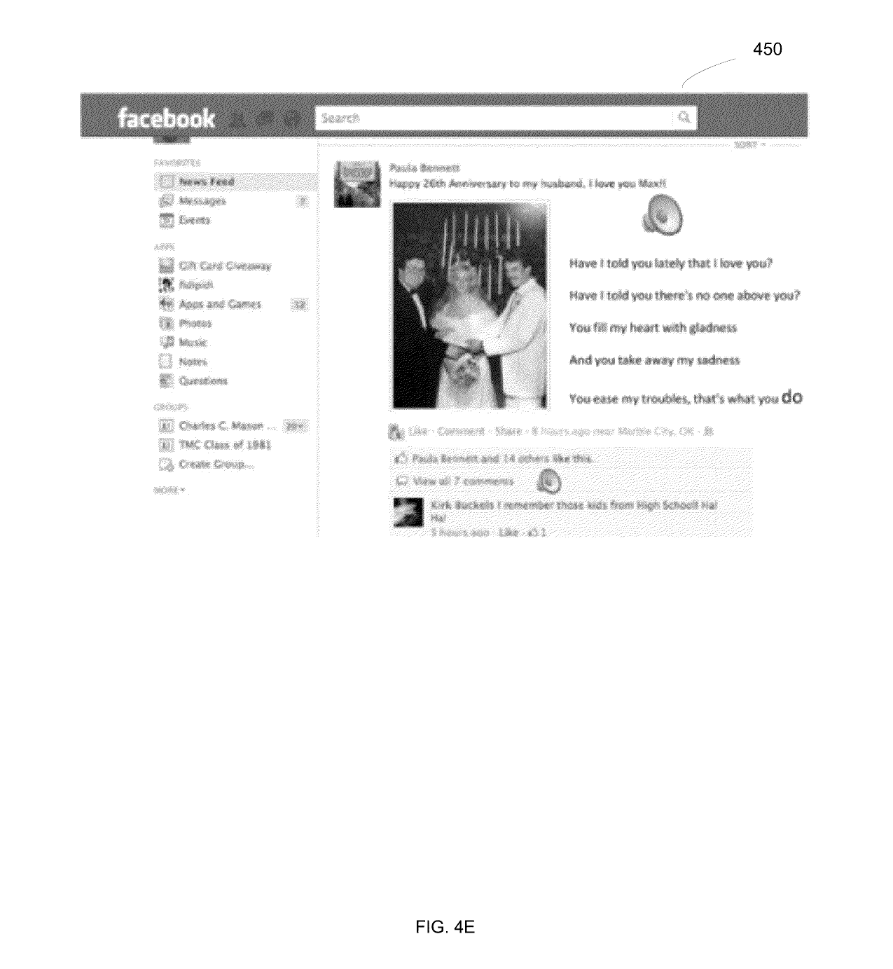

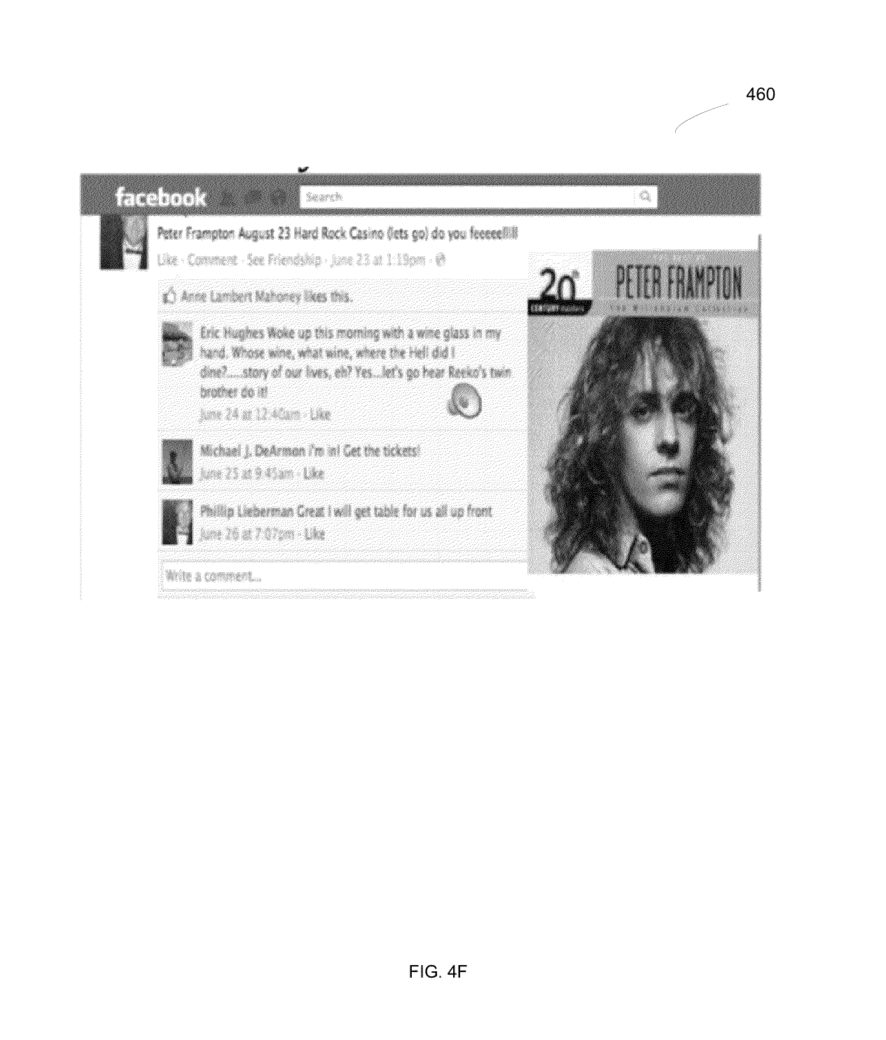

The example embodiments may be used to create lyrical messages, lyrical photo tags, lyrical eGreetings, and lyrical gift cards. FIG. 4A illustrates an example lyrical eGreeting card 410 having a portion (or snippet) of an audio/visual file attached thereto. FIG. 4B illustrates an example lyrical message 420 having a portion of an audio/visual file attached thereto. FIG. 4C illustrates an example lyrical photo tag 430 having a portion of an audio/visual file attached thereto. FIG. 4D illustrates example lyrical text (SMS) messages 440 each having a portion of an audio/visual file attached thereto. The lyrical text messages are not limited to SMS messages, and may also be MMS, etc. FIG. 4E illustrates an example anniversary message exchange on a social network 450 having a portion of an audio/visual file attached thereto. FIG. 4F illustrates an example lyrical post to a social network 460 having a portion of an audio/visual file attached thereto.

Aspects of the present disclosure relate to systems and methods for discovering, creating, editing, and communicating snippets of audio/visual content based on time-synced textual content, wherein the textual content is in the form of, for example, a narration, dialog, conversation, musical lyrics, etc. and appearing inside the audio/visual content. According to one embodiment, the time-synced textual content is delivered to users in conjunction with the audio/visual content as a single file, in multiple files, or even as a “file container” comprising multiple files. According to another embodiment, the time-synced textual content is not delivered to users, or alternately, delivered to users based on their desire to receive such content. According to yet another embodiment, the time-synced textual content is selected by users using hand movements on the touch screen display of an electronic device, or by cursor movements that can be reviewed on the screen of a computer.

Aspects of the present disclosure generally relate to locating and sharing audio/visual content using a content mapping and editing system (CMES) and methods for creating, editing, and communicating snippets of audio/visual content without the need to review the entire audio/visual file or use complicated editing software. Audio/visual (A/V) content can include TV shows, movies, music, speech, instructional videos, documentaries, pre-recorded sports events etc., or virtually any kind of audio or video file and in any digital format. The snippet is created in a suitable digital format and typically delivered (communicated) to users via a delivery mechanism involving email, SMS or MMS message, downloadable web link, mobile application software programs (mobile apps), or the like.

Accordingly, it will be understood that various embodiments of the present system described herein are generally implemented as a special purpose or general-purpose computer including various computer hardware as discussed in greater detail below. Embodiments within the scope of the present invention also include non-transitory computer-readable storage media for carrying or having computer-executable instructions or data structures stored thereon. Such computer-readable media can be any available media which can be accessed by a general purpose or special purpose computer. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection, but not transitory signals, is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernible from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

Those skilled in the art will appreciate the variations from the specific embodiments disclosed above are contemplated by the invention. The invention should not be restricted to the above embodiments, but should be measured by the following claims.

What is claimed is:

1. A method, comprising:
receiving, by at least one processor, a selection of a primary audio/visual content file;
retrieving, by the at least one processor, a text file that has text corresponding to audio in the primary audio/visual content file;
presenting, by the at least one processor, text from the text file for display;
receiving, by the at least one processor, a selection of text from the text file;
creating, by the at least one processor, a secondary file comprising a portion of the primary audio/visual content file, the portion having a start time and a stop time form the primary audio/visual content file that correspond to the text selection; and
sharing the portion of the primary audio/visual content file.

2. The method of claim 1 further comprising:
receiving, by the at least one processor, a search request for audio/visual content;
searching a storage, by the at least one processor, based on the search request;
presenting, by the at least one processor, a list of one or more audio/visual content determined to be relevant to the search request; and
receiving, by the at least one processor, the selection of the primary audio/visual content file from the list of audio/visual content.

3. The method of claim 2 wherein the search request comprises a text-based search request, the method comprising:
receiving, by the at least one processor, the text-based search request for audio/visual content;
searching the storage, by the at least one processor, based on the text-based search request; and
presenting, by the at least one processor, the list of one or more audio/visual content determined to be relevant to the text-based search request.

4. The method of claim 3, wherein presenting the list of one or more audio/visual content determined to be relevant to the search request comprises presenting the list of one or more audio/visual content at a display of a mobile application at a mobile device.

5. The method of claim 3, wherein presenting the list of one or more audio/visual content determined to be relevant to the search request comprises presenting the list of one or more audio/visual content via a web page comprising HTML-formatted text.

6. The method of claim 3, wherein searching the storage based on the search request comprises determining a best matching audio/visual content file for the text-based search request.

7. The method of claim 3 further comprising presenting a portion of the text file based on the text-based search request.

8. The method of claim 7 further comprising:
after receiving the text selection from the text file, determining the portion of the primary audio/visual content file that corresponds to the selected text by:
comparing the text selection to the text of the text file and timing data that identifies a time each word of text in the text file occurs as audio in the primary audio/visual content file to determine the start time of the text selection in the primary audio/visual content file and the stop time of the text selection in the primary audio/visual content file; and
extracting the portion of the primary audio/visual content file from the start time to the stop time; and
creating the secondary file with the extracted portion of the primary audio/visual content file, the portion having the start time and the stop time from the primary audio/visual content file that correspond to the text selection.

9. The method of claim 3, wherein the text-based search request corresponds with one of a genre, a song title, an artist name, song lyrics, a movie title, a television show title, a television show episode title, dialogue in a television show, dialogue in a movie, dialogue in a speech, dialogue in a documentary, dialogue in a sports event, a mood, and a sentiment.

10. The method of claim 3, the searching further comprising beginning searching the storage using a partially complete text-based search request.

11. The method of claim 1 further comprising:
after receiving the text selection from the text file, determining the portion of the primary audio/visual content file that corresponds to the selected text by:
comparing the text selection to the text of the text file and timing data that identifies a time each word of text in the text file occurs as audio in the primary audio/visual content file to determine the start time of the text selection in the primary audio/visual content file and the stop time of the text selection in the primary audio/visual content file; and
extracting the portion of the primary audio/visual content file from the start time to the stop time; and
creating the secondary file with the extracted portion of the primary audio/visual content file, the portion having the start time and the stop time from the primary audio/visual content file that correspond to the text selection.

12. The method of claim 1, wherein sharing the portion of the primary audio/visual content file comprises transmitting the secondary file for reception by a device of a user using one of email, short message service (SMS), multimedia messaging service (MMS), a uniform resource locator (URL), a mobile application, a social media network, an electronic greeting card, an electronic gift card, and a digital photo service.

13. The method of claim 1, wherein sharing the portion of the primary audio/visual content file comprises transmitting a uniform resource locator (URL) for reception by a device of a user that, when selected, causes the at least one processor to stream the portion of the primary audio/visual content file to the device.

14. The method of claim 1, further comprising sharing the selected text with the portion of the primary audio/visual content file.

15. The method of claim 1, further comprising sharing at least one of a message and a photo with the portion of the primary audio/visual content file.

16. The method of claim 1, further comprising transmitting the secondary file using a link that, when selected, causes the portion of the primary audio/visual content file to be downloaded and played at a device.

17. The method of claim 1, further comprising editing the secondary file responsive to input received by an input device.

18. The method of claim 1, further comprising editing the secondary file by modifying at least one of the start time and the stop time based on a revised text selection from the text file.

19. The method of claim 1, further comprising editing the secondary file by modifying at least one of the start time and the stop time.

20. The method of claim 1, wherein the storage comprises a database of audio files for songs and text of song lyrics with timing data that identifies, for each word of lyrics, a time the each word of lyrics in the text file occurs as audio in one of the audio files.

21. The method of claim 1, wherein the storage comprises a database of primary audio/visual content files and text files each with text and timing data that identifies a time each word of text in the text file occurs as audio in one of the primary audio/visual content files.

22. The method of claim 1 wherein the text file comprises a time-stamped text file that contains the text corresponding to the primary audio/visual file and time stamps to indicate the time the text occurs in the primary audio/visual file.

23. A system, comprising:
at least one processor to:
receive a selection of a primary audio/visual content file;
retrieve a text file that has text corresponding to audio in the primary audio/visual content file;
present text from the text file for display;
receive a text selection from the text file;
create a secondary file comprising a portion of the primary audio/visual content file, the portion having a start time and a stop time that correspond to the text selection; and
share the portion of the primary audio/visual content file with a recipient.

24. The system of claim 23, the at least one processor further to:
receive a search request for audio/visual content;
search a storage based on the search request;
present a list of one or more audio/visual content determined to be relevant to the search request; and
receive the selection of the primary audio/visual content file from the list of audio/visual content.

25. The system of claim 24, wherein the search request comprises a text-based search request, the at least one processor further to:
receive the text-based search request for audio/visual content;
search the storage based on the text-based search request; and
present the list of one or more audio/visual content determined to be relevant to the text-based search request.

26. The system of claim 25, the at least one processor further to present the list of one or more audio/visual content at a display of a mobile application at a mobile device.

27. The system of claim 25, the at least one processor further to present the list of one or more audio/visual content via a web page comprising HTML-formatted text.

28. The system of claim 25, the at least one processor further to determine a best matching audio/visual content file for the text-based search request.

29. The system of claim 25, the at least one processor further to present a portion of the text file based on the text-based search request.

30. The system of claim 29, the at least one processor further to:
after receiving the text selection from the text file, determine the portion of the primary audio/visual content file that corresponds to the selected text by:
comparing the text selection to the text of the text file and timing data that identifies a time each word of text in the text file occurs as audio in the primary audio/visual content file to determine the start time of the text selection in the primary audio/visual content file and the stop time of the text selection in the primary audio/visual content file; and
extracting the portion of the primary audio/visual content file from the start time to the stop time; and
create the secondary file with the extracted portion of the primary audio/visual content file, the portion having the start time and the stop time from the primary audio/visual content file that correspond to the text selection.

31. The system of claim 25, wherein the text-based search request corresponds with one of a genre, a song title, an artist name, song lyrics, a movie title, a television show title, a television show episode title, dialogue in a television show, dialogue in a movie, dialogue in a speech, dialogue in a documentary, dialogue in a sports event, a mood, and a sentiment.

32. The system of claim 25, the at least one processor further to begin searching the storage using a partially complete text-based search request.

33. The system of claim 23, the at least one processor further to:
after receiving the text selection from the text file, determine the portion of the primary audio/visual content file that corresponds to the selected text by:
comparing the text selection to the text of the text file and timing data that identifies a time each word of text in the text file occurs as audio in the primary audio/visual content file to determine the start time of the text selection in the primary audio/visual content file and the stop time of the text selection in the primary audio/visual content file; and
extracting the portion of the primary audio/visual content file from the start time to the stop time; and
create the secondary file with the extracted portion of the primary audio/visual content file, the portion having the start time and the stop time from the primary audio/visual content file that correspond to the text selection.

34. The system of claim 23, the at least one processor further to transmit the secondary file for reception by a device of a user using one of email, short message service (SMS), multimedia messaging service (MMS), a uniform resource locator (URL), a mobile application, a social media network, an electronic greeting card, an electronic gift card, and a digital photo service.

35. The system of claim 23, the at least one processor further to transmit a uniform resource locator (URL) for reception by a device of a user that, when selected, causes the at least one processor to stream the portion of the primary audio/visual content file to the device.

36. The system of claim 23, the at least one processor further to share the selected text with the portion of the primary audio/visual content file.

37. The system of claim 23, the at least one processor further to share at least one of a message and a photo with the portion of the primary audio/visual content file.

38. The system of claim 23, the at least one processor further to transmit the secondary file using a link that, when selected, causes the portion of the primary audio/visual content file to be downloaded and played at a device.

39. The system of claim 23, the at least one processor further to edit the secondary file responsive to input received by an input device.

40. The system of claim 23, the at least one processor further to edit the secondary file by modifying at least one of the start time and the stop time based on a revised text selection from the text file.

41. The system of claim 23, the at least one processor further to edit the secondary file by modifying at least one of the start time and the stop time.

42. The system of claim 23, wherein the storage comprises a database of audio files for songs and text of song lyrics with timing data that identifies, for each word of lyrics, a time the each word of lyrics in the text file occurs as audio in one of the audio files.

43. The system of claim 23, wherein the storage comprises a database of primary audio/visual content files and text files each with text and timing data that identifies a time each word of text in the text file occurs as audio in one of the primary audio/visual content files.

44. The system of claim 23 wherein the text file comprises a time-stamped text file that contains the text corresponding to the primary audio/visual file and time stamps to indicate the time the text occurs in the primary audio/visual file.

45. A non-transitory computer-readable medium having instructions stored thereon that, when executed by at least one computing device, cause the at least one computing device to perform operations comprising:
receiving a selection of a primary audio/visual content file;
retrieving a text file that has text corresponding to audio in the primary audio/visual content file;
presenting text from the text file for display;
receiving a text selection from the text file;
creating a secondary file comprising a portion of the primary audio/visual content file, the portion having a start time and a stop time from the primary audio/visual content file that correspond to the text selection; and
sharing the portion of the primary audio/visual content file.

46. The non-transitory computer-readable medium of claim 45, the operations further comprising:
receiving a search request for audio/visual content;
searching a storage based on the search request;
presenting a list of one or more audio/visual content determined to be relevant to the search request; and
receiving the selection of the primary audio/visual content file from the list of audio/visual content.

47. The non-transitory computer-readable medium of claim 46, wherein the search request comprises a text-based search request, the operations further comprising:
receiving the text-based search request for audio/visual content;
searching the storage based on the text-based search request; and
presenting the list of one or more audio/visual content determined to be relevant to the text-based search request.

48. The non-transitory computer-readable medium of claim 47, wherein presenting the list of one or more audio/visual content determined to be relevant to the search request comprises presenting the list of one or more audio/visual content at a display of a mobile application at a mobile device.

49. The non-transitory computer-readable medium of claim 47, wherein presenting the list of one or more audio/visual content determined to be relevant to the search request comprises presenting the list of one or more audio/visual content via a web page comprising HTML-formatted text.

50. The non-transitory computer-readable medium of claim 47, wherein searching the storage based on the search request comprises determining a best matching audio/visual content file for the text-based search request.

51. The non-transitory computer-readable medium of claim 47, the operations further comprising presenting a portion of the text file based on the text-based search request.

52. The non-transitory computer-readable medium of claim 51, the operations further comprising:
after receiving the text selection from the text file, determining the portion of the primary audio/visual content file that corresponds to the selected text by:
comparing the text selection to the text of the text file and timing data that identifies a time each word of text in the text file occurs as audio in the primary audio/visual content file to determine the start time of the text selection in the primary audio/visual content file and the stop time of the text selection in the primary audio/visual content file; and
extracting the portion of the primary audio/visual content file from the start time to the stop time; and
creating the secondary file with the extracted portion of the primary audio/visual content file, the portion having the start time and the stop time from the primary audio/visual content file that correspond to the text selection.

53. The non-transitory computer-readable medium of claim 47, wherein the text-based search request corresponds with one of a genre, a song title, an artist name, song lyrics, a movie title, a television show title, a television show episode title, dialogue in a television show, dialogue in a movie, dialogue in a speech, dialogue in a documentary, dialogue in a sports event, a mood, and a sentiment.

54. The non-transitory computer-readable medium of claim 47, the searching further comprising beginning searching the storage using a partially complete text-based search request.

55. The non-transitory computer-readable medium of claim 45, the operations further comprising:
after receiving the text selection from the text file, determining the portion of the primary audio/visual content file that corresponds to the selected text by:
comparing the text selection to the text of the text file and timing data that identifies a time each word of text in the text file occurs as audio in the primary audio/visual content file to determine the start time of the text selection in the primary audio/visual content file and the stop time of the text selection in the primary audio/visual content file; and
extracting the portion of the primary audio/visual content file from the start time to the stop time; and
creating the secondary file with the extracted portion of the primary audio/visual content file, the portion having the start time and the stop time from the primary audio/visual content file that correspond to the text selection.

56. The non-transitory computer-readable medium of claim 45, wherein sharing the portion of the primary audio/visual content file comprises transmitting the secondary file for reception by a device of a user using one of email, short message service (SMS), multimedia messaging service (MMS), a uniform resource locator (URL), a mobile application, a social media network, an electronic greeting card, an electronic gift card, and a digital photo service.

57. The non-transitory computer-readable medium of claim 45, wherein sharing the portion of the primary audio/visual content file comprises transmitting a uniform resource locator (URL) for reception by a device of a user that, when selected, causes the at least one processor to stream the portion of the primary audio/visual content file to the device.

58. The non-transitory computer-readable medium of claim 45, further comprising sharing the selected text with the portion of the primary audio/visual content file.

59. The non-transitory computer-readable medium of claim 45, further comprising sharing at least one of a message and a photo with the portion of the primary audio/visual content file.

60. The non-transitory computer-readable medium of claim 45, the operations further comprising transmitting the secondary file using a link that, when selected, causes the portion of the primary audio/visual content file to be downloaded and played.

61. The non-transitory computer-readable medium of claim 45, the operations further comprising editing the secondary file responsive to input received by an input device.

62. The non-transitory computer-readable medium of claim 45, the operations further comprising editing the secondary file by modifying at least one of the start time and the stop time based on a revised text selection from the text file.

63. The non-transitory computer-readable medium of claim 45, the operations further comprising editing the secondary file by modifying at least one of the start time and the stop time.

64. The non-transitory computer-readable medium of claim 45, wherein the storage comprises a database of audio files for songs and text of song lyrics with timing data that identifies, for each word of lyrics, a time the each word of lyrics in the text file occurs as audio in one of the audio files.

65. The non-transitory computer-readable medium of claim 45, wherein the storage comprises a database of primary audio/visual content files and text files each with text and timing data that identifies a time each word of text in the text file occurs as audio in one of the primary audio/visual content files.

66. The non-transitory computer-readable medium of claim 45 wherein the text file comprises a time-stamped text file that contains the text corresponding to the primary audio/visual file and time stamps to indicate the time the text occurs in the primary audio/visual file.

67. A method, comprising:
receiving, by at least one processor, a text-based search request for audio/visual content;
searching storage, by the at least one processor, based on the text-based search request;
presenting, by the at least one processor, a list of one or more audio/visual content determined to be relevant to the text-based search request;
receiving, by at least one processor, a selection of a primary audio/visual content file;
retrieving, by the at least one processor, a text file that has text corresponding to audio in the primary audio/visual content file;
presenting, by the at least one processor, text from the text file for display;
receiving, by the at least one processor, a selection of text from the text file;
creating, by the at least one processor, a secondary file comprising a portion of the primary audio/visual content file, the portion having a start time and a stop time from the primary audio/visual content file that correspond to the text selection; and
sharing the portion of the primary audio/visual content file.

68. The method of claim 67 wherein the text file comprises a lyric file with lyrics, and the primary audio/visual content file comprises an audio song file.

69. The method of claim 68 further comprising:
after receiving the text selection from the text file, determining the portion of the primary audio/visual content file that corresponds to the selected text by:
comparing the text selection to the text of the text file and timing data that identifies a time each word of text in the text file occurs as audio in the primary audio/visual content file to determine the start time of the text selection in the primary audio/visual content file and the stop time of the text selection in the primary audio/visual content file; and
extracting the portion of the primary audio/visual content file from the start time to the stop time; and
creating the secondary file with the extracted portion of the primary audio/visual content file, the portion having the start time and the stop time from the primary audio/visual content file that correspond to the text selection.

70. The method of claim 67 wherein the text file comprises a time-stamped text file that contains the text corresponding to the primary audio/visual file and time stamps to indicate the time the text occurs in the primary audio/visual file.

71. A system, comprising:
a processor to:
receive a text-based search request for audio/visual content;
search based on the text-based search request;
presenting, by the at least one processor, a list of one or more audio/visual content determined to be relevant to the text-based search request;
receive a selection of a primary audio/visual content file;
retrieve a text file that has text corresponding to audio in the primary audio/visual content file;
present text from the text file for display;
receive, a selection of text from the text file;
create a secondary file comprising a portion of the primary audio/visual content file, the portion having a start time and a stop time form the primary audio/visual content file that correspond to the text selection; and
share the portion of the primary audio/visual content file.

72. The system of claim 71 wherein the text file comprises a lyric file with lyrics, and the primary audio/visual content file comprises an audio song file.

73. The system of claim 72 wherein the at least one processor further:
after receiving the text selection from the text file, determines the portion of the primary audio/visual content file that corresponds to the selected text by:
comparing the text selection to the text of the text file and timing data that identifies a time each word of text in the text file occurs as audio in the primary audio/visual content file to determine the start time of the text selection in the primary audio/visual content file and the stop time of the text selection in the primary audio/visual content file; and
extracting the portion of the primary audio/visual content file from the start time to the stop time; and
creates the secondary file with the extracted portion of the primary audio/visual content file, the portion having the start time and the stop time from the primary audio/visual content file that correspond to the text selection.

74. The system of claim 71 wherein the text file comprises a time-stamped text file that contains the text corresponding to the primary audio/visual file and time stamps to indicate the time the text occurs in the primary audio/visual file.
